(19) United States
(12) Patent Application Publication
(10) Pub. No.: US 2009/0027792 A1
(43) Pub. Date: Jan. 29, 2009

(54) Reflector for a solar energy collection system and a solar energy collection system

(75) Inventors: Johan Frederick Dreyer, Gordon (AU); Antoine Millioud, Allschwil (CH)

Correspondence Address: WEINGARTEN, SCHURGIN, GAGNEBIN & LEBOVICI LLP, TEN POST OFFICE SQUARE, BOSTON, MA, 02109, US

(73) Assignee: NEP SOLAR PTY LTD, Gordon (AU)

(21) Appl. No.: 12/217,525

(22) Filed: Jul. 3, 2008

Related U.S. Application Data
(63) Continuation of application No. PCT/AU2006/001989, filed on Dec. 28, 2006.

(30) Foreign Application Priority Data
Jan. 6, 2006 (AU) 2006900064

(51) Int. Cl. G02B 7/183; B29D 11/00

(52) U.S. Cl. 359/883; 264/1.9; 359/846

(57) ABSTRACT

The present invention provides a reflector for a solar energy collection system. The reflector comprises a reflective material for receiving solar radiation and directing the received solar radiation to an absorber. The reflector also comprises a polymeric body supporting the reflective material. The polymeric body comprises a polymeric core that is sandwiched by at least one polymeric layer.

This application claims priority to International Application No. PCT/AU2006/001989, with an international filing date of Dec. 28, 2006, which claims priority from Austrian Patent Application No. 2006900064 filed Jan. 6, 2006.

### FIELD OF THE INVENTION

The present invention broadly relates to a reflector for a solar energy collection system and to a solar energy collection system.

### BACKGROUND OF THE INVENTION

Solar energy collection systems are used to receive incident solar radiation and direct the received solar radiation to an absorber. The absorber typically comprises a fluid that absorbs the radiation directly or absorbs generated thermal energy which may then be converted into energy of another form such as electrical energy.

For example, such a solar energy collection system may comprise an array of solar energy reflectors which direct the solar radiation towards a central absorber that is located on a tower over the array. Alternatively, each reflector may comprise an individual absorber. In this case each reflector has a reflective surface that typically is of a parabolic cross-sectional shape and a respective absorber is positioned in a focal region of each reflective surface. For example, such a reflective surface may be elongate and rectilinear with a parabolic cross-sectional shape in a plane perpendicular to the direction of elongation. Alternatively, the reflective surface may be a parabolic dish (or paraboloid). Each reflector typically comprises a support structure that is moveable by a drive and arranged so that the relative movement of the sun can be tracked. Such reflectors can be relatively large and may be exposed to strong winds. It is therefore important to provide a support structure having sufficient stability and to maintain the parabolic shape. However, in order to reduce cost and facilitate assembly, it is also advantageous to fabricate the support structure having as few components as possible and such that the manufacturing and assembly process can be automated.

The support structures of reflectors known to date are relatively complex structures having a large number of components and requiring manual assembly or where simple structures are used are either costly to manufacture or are not form stable over time and at elevated temperatures. There is a need for technological advancement.

### SUMMARY OF THE INVENTION

The present invention provides in a first aspect a reflector for a solar energy collection system, the reflector comprising:
a reflective material for receiving solar radiation and directing the received solar radiation to an absorber,
a polymeric body supporting the reflective material, the polymeric body comprising a polymeric core sandwiched by at least one polymeric layer.

The at least one polymeric layer typically comprises a fibre reinforced polymeric material.

The polymeric body, either with or without fibre reinforcement of that at least one polymeric layer layer, typically has a stiffness (such as a torsional and/or bending stiffness) that is sufficient for supporting the reflective material so that a predetermined shape is maintained. Alternatively, the torsional stiffness of the body may be facilitated by a torque member, such as a torque tube that may be attached to the body. The stiffness that is provided allows design of the polymeric body with only a minimum number of components and significant simplicity compared with known framework support structures (such as metal framework structures comprising a large number of components). The simplicity facilitates assembly and therefore reduces costs.

The polymeric core typically comprises a polymeric foam material and typically is arranged to separate opposite portions of the at least one polymeric layer from each other, which maintains stability. The polymeric core material may comprise polystyrene or polyurethane, with or without fibre reinforcement. Alternatively, the polymeric core material may comprise epoxy or polyvinyl chloride (PVC) such as cross-linked or linear PVC, polypropylene or polyethylene plastics, or thermosetting plastics.

The polymeric core may be integrally formed from one material. The core may also comprise polymeric core materials which are separately formed. For example, a first section of the polymeric core may be composed of a first polymeric material and a second section of the polymeric core may be composed of a second polymeric material.

The at least one polymeric layer may comprise any suitable polymeric material, such as polyurethane or related materials. If the at least one polymeric layer comprises a fibre reinforced material, the at least one polymeric layer may for example comprise glass, aramid (Kevlar) or carbon fibres or any other suitable fibres and a matrix of, for example, polyester, vinyl ester, epoxy, phenolic or any other suitable polymeric material.

The at least one polymeric layer may enclose the polymeric core material or may cover a portion of the polymeric core material. The at least one polymeric layer may be adhered or otherwise mechanically coupled to the polymeric core material.

The reflective material may comprise glass that is coated with a metallic reflective coating or may be provided in form of a sheet material such as a metallic sheet that may be coated and/or polished. The reflective material may also be provided in form of a foil, which may comprise a metallic and/or a polymeric layer.

The reflective material may have a thermal expansion coefficient that is substantially the same as that of the polymeric body so that thermal stresses of the reflective material and/or the polymeric body resulting from temperature fluctuations can be largely avoided. In this case the reflective material typically is adhered to the body using a suitable adhesive.

Alternatively, the reflective material may be attached to the polymeric body during formation of the polymeric body so that the polymeric material of the polymeric body itself holds the reflective material without additional adhesive.

The reflective material may also comprise a reflective coating that is applied to a surface of the polymeric body.

The reflective material may also be attached to the polymeric body so that the reflective material and the polymeric body can expand or contract independently from each other. Such a loose coupling between the reflective material and the polymeric body is particularly advantageous if the reflective material and the polymeric body comprise materials that have differing thermal expansion coefficients. The reflective material may be clipped onto the polymeric body in a manner such that the reflector and the polymeric body can move relative to each other by a predetermined distance.

The reflective material may be flat or curved. In one specific embodiment the reflective material is elongate and has a parabolic cross-sectional shape in a plane perpendicular to the direction of elongation.

The reflective material may be integrally formed. Alternatively, the reflective material may comprise two or more elements.

The reflector may also comprise a holder for holding the absorber such as an absorber tube through which in use a fluid is directed. Further, the reflector may comprise the absorber.

In addition, the reflector may comprise a mount for mounting the body onto a ground plane. The mount typically comprises two end-members which are attached to portions of the polymeric body and which comprise a pivot about which the reflector is pivotable to track a relative movement of the sun. Alternatively, the body may be attached to the mount via a torque tube. The reflector may comprise a linear actuator for pivoting the polymeric body and the reflective material.

Formation of the polymeric core may comprise shaping blocks of the polymeric material into a desired shape. Alternatively the formation of the polymeric body may comprise an injection or pressure moulding process. The at least one polymeric layer, which for example may comprise glass fibre, may be mounted to the polymeric core using techniques such as vacuum mould infusion or resin transfer moulding.

The present invention provides in a second aspect a solar energy collection system comprising the reflector according to the first aspect of the present invention and further comprising an absorber for absorbing the solar radiation, the absorber comprising:
a metallic absorber tube arranged for throughput of a fluid,
a glass tube surrounding the metallic absorber tube, and
a convection suppression element positioned along a portion of the metallic tube and being arranged to reduce loss of thermal energy.

The convection suppression element typically comprises a hood positioned along a portion of the glass tube that is in use directed away from the reflective material. Alternatively, the convection suppression element may comprise a hood that is positioned in the interior of the glass tube and along an inner portion of the glass tube that in use is directed away from the reflective material. In this case the hood may comprise support elements, such as fins, that may support the hood on the metallic tube. The hood may be formed from a polymeric material. The hood may also comprise a reflective material that in use is oriented towards the reflector.

The present invention provides in a third aspect a solar energy collection system comprising:
an absorber for absorbing solar radiation,
a reflective material for directing solar radiation towards the absorber,
a body supporting the reflective material so that the reflective material maintains a predetermined shape, the body comprising a core that is formed from a polymeric material,
a mount for mounting the body onto a ground plane, the mount being arranged for pivoting the body with the reflective material, and
a linear actuator for pivoting the body and the reflective material and thereby tracking the relative movement of the sun.

The linear actuator typically is arranged to move the body with the reflective material directly without an intermediate lever and typically also without a geared arrangement.

The present invention provides in a fourth aspect method of fabricating a reflector for a solar energy collection system, the method comprising:
providing a moulding element having a surface portion, the surface portion having a shape that corresponds to, or approximates, an inverse of that of the reflective surface of the reflector,
positioning reflective material on the surface portion of the moulding element and
forming a body for supporting the reflective material, the body being formed from a polymeric material and adjacent the reflective material in a manner such that the polymeric material adheres to the reflective material during hardening of the polymeric material and the polymeric body adheres to the reflective material without additional adhesive material.

The reflective surface of the reflector typically has a concave cross-sectional shape and the surface portion of the moulding element typically has a convex cross-sectional shape having a curvature that is inverse to that of the concave reflective surface.

The formation of the body may comprise an injection or pressure moulding process.

The method may comprise the step of permanently bending the reflective material, which may for example be provided in the form of a sheet or foil, into a predetermined shape that is inverse to that of the surface portion of the moulding element.

Alternatively, the reflective material may also be draped onto the surface portion of the moulding element and held in that draped position during formation of the polymeric body. For example, the reflective material, which may be provided in form of a flat sheet or foil, may be draped over the surface portion of the moulding element without the need for initially permanently bending the reflective material into a predetermined shape that is inverse to that of the surface portion. This has significant practical advantages as less processing steps are required for fabricating the reflector. Once the polymeric body has been formed, the polymeric body will then support the reflective material so that the predetermined shape of the reflective surface, such as a convex shape, is maintained.

The invention will be more fully understood from the following description of specific embodiments of the invention. The description is provided with reference to the accompanying drawings.

### BRIEF DESCRIPTION OF THE DRAWINGS

FIG. 1 shows a reflector for a solar energy collection system according to a specific embodiment of the present invention,

FIG. 2 shows components of the reflector shown in FIG. 1,

FIG. 3 shows a solar energy collection system according to a specific embodiment of the present invention,

FIGS. 4 (a) and (b) show a reflector according to a further embodiment of the present invention,

FIG. 5 shows an absorber according to a specific embodiment of the present invention and

FIG. 6 shows an absorber according to another specific embodiment of the present invention.

### DETAILED DESCRIPTION OF SPECIFIC EMBODIMENTS

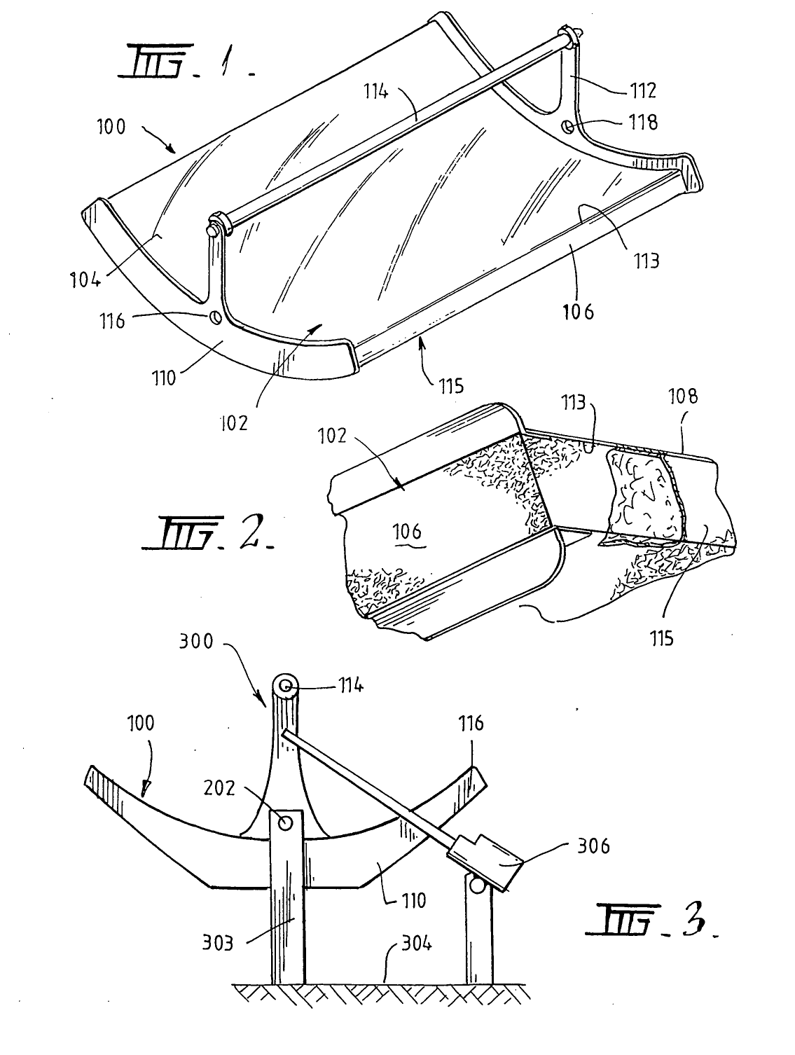

Referring initially to FIGS. 1 and 2, a reflector for a solar energy collection system according to a specific embodiment is now described. The reflector 100 comprises a body 102 which supports a reflective material 104. In this embodiment the reflective material 104 has a parabolic shape. It is to be appreciated, however, that the reflective material 104 may alternatively have any other suitable form. The body 102 comprises a core 106 of a polymeric material which is enclosed by an outer layer 108 that is also composed of a polymeric layer material.

The reflector 100 also comprises end-plates 110 and 112 which are arranged for holding the body 102 on a mount (not shown) and for holding an absorber 114 over the reflective material 104. Further, the end-plates 110 and 112 comprise recesses 116 and 118 for receiving pins for attachment to the mount and about which the body 102 with the reflective material 104 may be pivoted to track the relative movement of the sun.

The body 102 typically comprises a support surface 113 which has a shape that approximates that of the reflective material 104. A back-portion 115 of the body 102 may have any suitable shape and may comprise flat or curved.

In this embodiment the absorber 114 comprises a metallic tube that is surrounded by a glass tube and through which, in use, a fluid is directed which absorbs the solar energy. Generated heat energy may then be converted into other energy forms such as electrical energy.

The reflective material 104 is in this embodiment a metallic sheet that is supported by the body 102. The metallic sheet is composed of polished aluminium, but may alternatively be composed of any other suitable reflective metallic material. In this embodiment the metallic sheet is adhered to the body 102. Alternatively, the metallic sheet may also be clipped onto the body 102 in a relatively loose manner so that the body 102 and the reflective material 104 can independently expand or contract as a function of temperature fluctuations. In a further variation the reflective material 104 may be a reflective coating of the body 102 or may comprise a polymeric layer that is reflective and that has a thermal expansion coefficient similar to that of the body 102.

The polymeric core 106 may, for example, be composed of expanded polystyrene, expanded polyurethane, fibre reinforced polyurethane, a linear PVC foam or cross-linked PVC foam, polypropylene or polyethylene.

The polymeric core is integrally formed. Alternatively, the polymeric core 106 may be composed of two or more components which may comprise different materials. The outer layer 108 encloses in this embodiment the polymeric core 106.

In this embodiment the polymeric core 106 is a polymeric foam and the outer layer 108 is a fibre reinforced polymeric layer. The polymeric core 106 separates opposite portions of the fibre reinforced outer layer 106, which results in a relatively strong polymeric sandwich structure. The sandwich structure has sufficient strength, either by itself or together with a torque tube, to overcome forces that may in use be imposed by loads on the structure, such as bending and torsion forces, caused mainly by wind acting on the reflector 100. For example, the outer layer 108 may comprise a thermo-plastic polyurethane material, glass fibre materials, PVC materials or metallic materials. The polymeric material that forms the polymeric core may also be a fibre reinforced material, such a fibre reinforced polyurethane.

The body 102 may have a width of approximately 30 to 150 cm and a length by module of 1 m to 6 m, or any longer length as allowed by manufacturing process. Alternatively, the body 102 may have any other suitable dimensions.

The body with attached reflective material may be formed as follows. The reflective material, such as an aluminium foil, may initially be permanently bent into the desired concave shape and positioned on a surface portion of a moulding element that has a matching convex shape. Alternatively, the reflective material, for example provided in form of a flat sheet or foil, may be draped onto the surface portion of the moulding element and held in that position during formation of the polymeric body without initial bending the of reflective material. Glass fibre material is then positioned onto the rear side on the reflective material and the polymeric form material is added followed by a further layer of glass fibre material. A vacuum bag is the positioned over the arrangement. A suitable polymeric resin is then sucked into the vacuum bag in a manner such that the glass fibre material is soaked with the polymeric resin material. After hardening and curing of the polymeric resin material, the vacuum bag is removed. In this manner a polymeric sandwich structure is formed, which is directly bonded to the reflective material without the need for any additional adhesive material. In order to avoid that the polymeric resin material contaminates the reflective surface of the reflective material, a self-adhering protective layer is positioned on the reflective surface prior to formation of the polymeric sandwich structure and removed after its formation.

Alternatively, the moulding element may comprise portions that can be closed so that the interior of the closed moulding element has a shape that corresponds to an inverse of that of the reflector. In this case a sheet or foil of reflective material may be positioned on a suitably shaped surface portion of the moulding element and materials for the formation of the polymeric body may be positioned on the rear side of the reflective material. For example, the material for formation of the polymeric body may comprise a resin that includes fibres for forming fibre reinforced polymeric materials and that may be sprayed or coated on the rear side of the reflective material. Alternatively, the fibres may initially be positioned and the resin may be applied thereafter. For formation of the body, that will adhere to the reflective material as above, the moulding element can be closed and the use of a vacuum bag is in this variation not required.

Narrower reflectors may also comprise polymeric core materials that comprise a hollow portion.

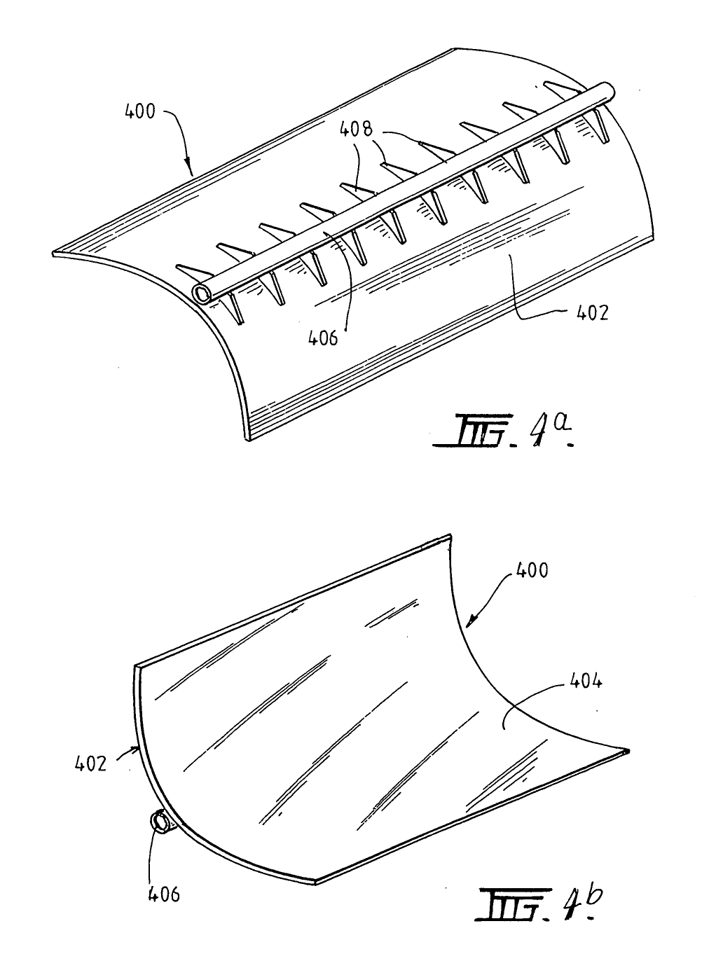

Referring now to FIG. 3, a solar energy collection system according to a specific embodiment of the present invention is described. The solar energy collection system 300 comprises the above-described reflector 100. Pins 202 are inserted into recesses 116 and 118 and the body 102 is held by the pins 302 on a support member 303 positioned on a ground plane 306. In this embodiment, a linear actuator 306 is coupled to end plate 110 of the body 102 in a tiller-like arrangement so that the body 102 can be pivoted by the linear actuator 306 about pins 302. A person skilled in the art will appreciate that with such an arrangement the body 102 may be pivoted by an angle of almost 180°, which is sufficient to track the relative movement of the sun.

Referring now to FIGS. 4 (a) and (b), a reflector according to a further embodiment of the present invention is described. The reflector 400 comprises a body 402 and a reflective material 404. In this embodiment the body 402 comprises a polymeric sandwich structure, which supports the reflective material 404. The body 402 comprises a core formed from a polymeric foam material, such as a cross-linked PVC foam material. The polymeric core is sandwiched by a fibre reinforced polymeric material and the body 402 is attached to a metallic torque tube 406 via polymeric support elements 408. The polymeric sandwich structure of the body 402, to which the reflective material 404 is directly attached, is formed using the above-descried method.

The body 402 is arranged to withstand bending loads and transfer torsional loads from the reflective material 404 to the metallic torque tube 406. The metallic torque tube 406 is in use attached to a tiller arrangement which allows movement of the reflector with the torque tube about an axis of the torque tube 406. The tiller arrangement is similar to that described above and shown in FIG. 3.

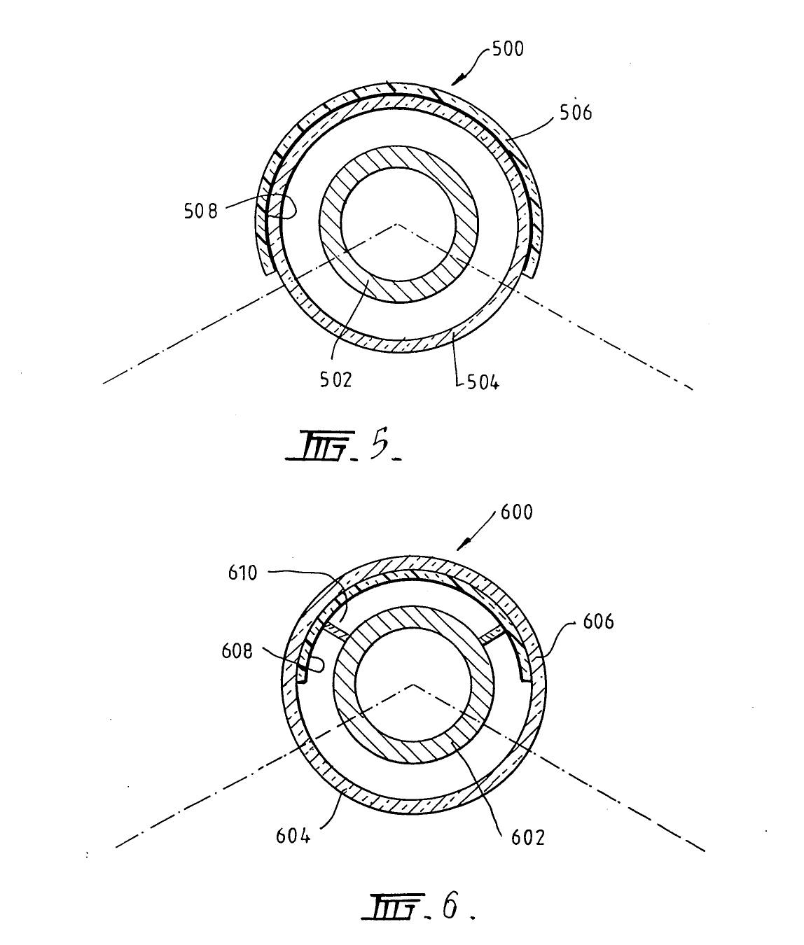

Referring now to FIG. 5, an absorber 500 for the above-described reflector is now described. The dashed lines in FIG. 5 indicate an angular range form which solar radiation is received from the reflective surface. The above-described reflector and the absorber 500 together form a solar energy collection system. The absorber 500 comprises a metallic absorber tube 502 for throughput of a fluid. The metallic absorber tube 502 is surrounded by a glass tube 504. A convection suppression element, which in this embodiment comprises hood 506, is positioned outside the glass tube 504 and along the length of the glass tube 504. The hood 506 is directed away from the reflector. The hood 506 is made of a material which has high thermal insulation properties. Such material may comprise glass or rock fibres or a polymeric material such as polyurethane. In this embodiment the hood 506 has a reflective foil 508 attached to an inner portion and directed to reflect radiation emitted form the absorber tube 502.

Referring now to FIG. 6, an absorber 600 for the above-described reflector is now described. The absorber 600 is closely related to the absorber 500 shown in FIG. 5. The dashed lines in FIG. 6 indicate an angular range form which solar radiation is received from the reflector. The absorber 600 comprises a metallic absorber tube 602 for throughput of a fluid. The metallic absorber tube 602 is surrounded by a glass tube 604. A convection suppression element, which in this embodiment comprises hood 606, is positioned along the length of the glass tube 604. The hood 606 is directed away from the reflector. In contrast to the absorber 500 described above, the hood 606 is positioned along the inside of the glass tube 604. The hood 606 has a reflective coating 608 and support elements 610 that support the hood 606 on the absorber tube 602.

Although the invention has been described with reference to particular examples, it will be appreciated by those skilled in the art that the invention may be embodied in many other forms. For example, the outer layer of the polymeric sandwich structure may be surrounded by another layer that may not be polymeric.

1. A reflector for a solar energy collection system, the reflector comprising:
a reflective material for receiving solar radiation and directing the received solar radiation to an absorber,
a polymeric body supporting the reflective material, the polymeric body comprising a polymeric core and at least two polymeric layer portions, the polymeric core being positioned between the at least two polymeric layer portions,
wherein the reflective material is directly attached to the polymeric body during formation of the polymeric body.

2. The reflector of claim 1 wherein the reflective material is directly attached to the polymeric body during formation of the at least two polymeric layer portions.

3. The reflector of claim 1 wherein the at least two polymeric layer portions comprise a fibre reinforced material.

4. The reflector of claim 1 wherein the polymeric body has a stiffness that is sufficient for supporting the reflective material so that the reflective material maintains a predetermined shape.

5. The reflector of claim 1 comprising a torque member facilitating the torsional stiffness of the polymeric body and wherein the polymeric body and the torque member together have a stiffness that is sufficient for supporting the reflective material so that the reflective material maintains a predetermined shape.

6. The reflector of claim 1 wherein the polymeric core is integrally formed.

7. The reflector of claim 1 wherein the polymeric core material comprises portions that are separately formed.

8. The reflector of claim 7 wherein a first section of the polymeric core is composed of a first polymeric material and a second section of the polymeric core is composed of a second polymeric material.

9. The reflector of claim 1 wherein the at least two polymeric layer portions enclose the polymeric core.

10. The reflector of claim 1 wherein the reflective material comprises glass that is coated with a metallic reflective coating.

11. The reflector of claim 1 wherein the reflective material comprises a polymeric layer.

12. The reflector of claim 1 wherein the reflective material is a sheet material.

13. The reflector of claim 1 wherein the reflective material is a foil.

14. The reflector of claim 13 wherein the reflective material comprises a metallic material.

15. A method of fabricating a reflector for a solar energy collection system, the method comprising:
providing a moulding element having a surface portion,
positioning a reflective material relative to the surface portion of the moulding element, and
forming a body for supporting the reflective material adjacent the reflective material, forming the body comprising forming a polymeric material in a manner such that the reflective material is directly adhered to the formed polymeric material.

16. The method of claim 15 wherein the reflective element is positioned on the surface portion of the moulding element.

17. The method of claim 15 wherein the surface portion of the moulding element has a shape that corresponds to, or approximates, an inverse of that of the reflective surface of the reflector.

18. The method of claim 15 wherein the body comprises a polymeric core and at least two polymeric layer portions, the polymeric core being positioned between the at least two polymeric layer portions, and wherein forming the polymeric body comprises:
positioning the polymeric core relative to a mould that comprises the moulding element on which the reflective material is positioned and
directing a polymeric resin into the mould so that the polymeric layer portions are formed and the reflective material directly adheres to at least one of the formed polymeric layer portions.

19. The method of claim 18 comprising positioning fibre reinforcing material into the mould so that the formed polymeric layer portions are fibre reinforced.

20. The method of claim 15 wherein the reflective surface of the reflector has a concave cross-sectional shape and the surface portion of the moulding element has a convex cross-sectional shape having a curvature that is inverse to that of the concave reflective surface.

21. The method of claim 15 comprising the step of permanently bending the reflective material before positioning the reflective material, the reflective material being bent into a shape that corresponds to an inverse of that of the surface portion of the moulding element.

22. The method of claim 15 comprising draping the reflective material onto the surface portion of the moulding element and holding the reflective material in the draped position during formation of the polymeric body.

23. The method of claim 15 wherein the reflective material comprises glass that is coated with a metallic reflective coating.

24. The method of claim 15 wherein the reflective material comprises a polymeric layer.

25. The method of claim 15 wherein the reflective material is a sheet material.

26. The method of claim 15 wherein the reflective material is a foil.

27. The method of claim 26 wherein the reflective material comprises a metallic material.
